(19) United States
(12) Patent Application Publication
(10) Pub. No.: US 2019/0031795 A1
(43) Pub. Date: Jan. 31, 2019

(54) INSULATED ELECTRICAL WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Tsuyoshi NONAKA, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/083,095

(22) PCT Filed: Mar. 13, 2017
(86) PCT No.: PCT/JP2017/009872

§ 371 Date: Sep. 7, 2018

(30) Foreign Application Priority Data
Mar. 31, 2016 (JP) 2016-070995

(51) Int. Cl. C08F 210/02; C08F 14/18; C08F 16/24; H01B 3/44; H01B 3/30

(52) U.S. Cl. CPC C08F 210/02; C08F 14/185; C08F 16/24; H01B 7/292; H01B 3/307; C08F 2800/10; H01B 3/445

(57) ABSTRACT

Provided is an insulated electrical wire having an insulating layer containing a fluororesin, wherein the flexibility is improved while maintaining the heat resistance of the fluororesin. The insulated electrical wire comprises a conductor and an insulating layer covering the periphery of the conductor, the insulating layer containing a fluorine-containing polymer comprising a polymer of a monomer containing one or two or more fluorine-containing monomers represented by the following formula (1):

CH₂═CH—Rf¹ (1)

wherein Rf¹ is a perfluoroalkyl group, and Rf¹ may contain one or more ether bonds.

### TECHNICAL FIELD

The present invention relates to an insulated electrical wire, and more specifically to an insulated electrical wire suitably used for vehicles, such as automobiles.

### BACKGROUND ART

Fluororesins that have excellent heat resistance and chemical resistance are sometimes used as insulating materials for insulated electrical wires used for vehicles, such as automobiles.

### CITATION LIST

### Patent Literature

PTL 1: JP2011-18634A

### SUMMARY OF INVENTION

### Technical Problem

Conventionally known fluororesins include polytetrafluoroethylene (PTFE), copolymers of tetrafluoroethylene and hexafluoropropylene (FEP), and copolymers of tetrafluoroethylene and perfluoroalkoxy trifluoroethylene (PFA). These fluororesins are excellent in heat resistance, but are inferior in flexibility. Accordingly, these fluororesins can be applied as insulating materials for thin-diameter electrical wires; however, it is difficult to apply them as insulating materials for thick power cables or the like due to their insufficient flexibility.

When fluororubber that has superior flexibility to fluororesins is used as an insulating material, vulcanization (crosslinking) is required for the fluororubber to exhibit practical properties as rubber, and the vulcanization (crosslinking) step reduces productivity and increases production costs. Further, there is a possibility that heat resistance is lowered because the fluorine concentration is reduced due to a vulcanizing agent (crosslinking agent) and a vulcanization aid (crosslinking aid), which are used during vulcanization (crosslinking).

The problem to be solved by the present invention is to provide an insulated electrical wire having an insulating layer containing a fluororesin, wherein the flexibility is improved while maintaining the heat resistance of the fluororesin.

### Solution to Problem

The insulated electrical wire according to the present invention for solving the above problem comprises a conductor and an insulating layer covering the periphery of the conductor, the insulating layer containing a fluorine-containing polymer comprising a polymer of a monomer containing one or two or more fluorine-containing monomers represented by the following formula (1):

[Chem 1]

CH₂═CH—Rf¹ (1)

wherein Rf¹ is a perfluoroalkyl group, and Rf¹ may contain one or more ether bonds.

The fluorine-containing monomer represented by the formula (1) is preferably one or two or more fluorine-containing monomers represented by the following formulas (2) to (5):

[Chem 2]

CH₂═CH—Rf² (2)

wherein Rf² is a perfluoroalkyl group comprising a carbon atom and a fluorine atom;

[Chem 3]

CH₂═CH-0-Rf³ (3)

wherein Rf³ is a perfluoroalkyl group comprising a carbon atom and a fluorine atom;

[Chem 4]

CH₂═CH—CF₂—Rf⁴IC (4)

wherein Rf⁴ is a perfluoroalkyl group containing one or more ether bonds; and

[Chem 5]

CH₂═CH-0-CF₂—Rf⁵ (5)

wherein Rf⁵ is a perfluoroalkyl group containing one or more ether bonds.

The fluorine-containing monomer represented by the formula (4) is preferably a fluorine-containing monomer represented by the following formula (6)

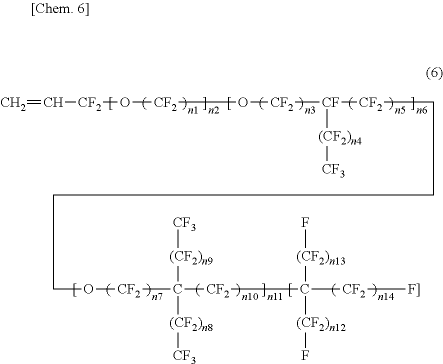

The fluorine-containing monomer represented by the formula (5) is preferably a fluorine-containing monomer represented by the following formula (7)

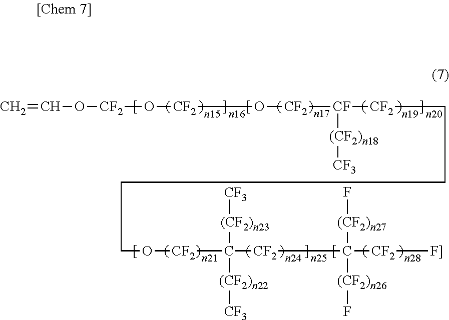

In the insulated electrical wire according to the present invention, the periphery of the conductor is preferably covered with an insulating layer containing a fluorine-containing polymer comprising a polymer of one or two or more fluorine-containing monomers represented by the formula (1).

In the insulated electrical wire according to the present invention, the periphery of the conductor is preferably covered with an insulating layer containing a fluorine-containing polymer comprising a copolymer of one or two or more fluorine-containing monomers represented by the formula (1) and ethylene.

Two monomers preferably constitute the fluorine-containing polymer.

One monomer preferably constitutes the fluorine-containing polymer.

The copolymerization ratio of the ethylene is preferably 50 mol % or less.

The fluorine-containing polymer is preferably thermoplastic.

### Advantageous Effects of Invention

According to the insulated electrical wire of the present invention, because the periphery of the conductor is covered with an insulating layer containing a fluorine-containing polymer comprising a polymer of a monomer containing one or two or more fluorine-containing monomers represented by the formula (1), the flexibility can be improved while maintaining the heat resistance of the fluororesin. Because a flexible fluororesin is use as an insulating material, flexibility can be ensured even in thick electrical wires, such as power cables.

When the fluorine-containing monomer represented by the formula (3) or (5) is used as the fluorine-containing monomer represented by the formula (1), polymerizability can be improved, the yield of high-molecular-weight polymers can be increased, and heat resistance can be improved.

In the insulated electrical wire according to the present invention, when the periphery of the conductor is covered with an insulating layer containing a fluorine-containing polymer comprising a polymer of one or two or more fluorine-containing monomers represented by the formula (1), excellent heat resistance can be exhibited because the fluorine content is relatively high.

In the insulated electrical wire according to the present invention, when the periphery of the conductor is covered with an insulating layer containing a fluorine-containing polymer comprising a copolymer of one or two or more fluorine-containing monomers represented by the formula (1) and ethylene, polymerizability can be improved, the yield of high-molecular-weight polymers can be increased, and heat resistance can be improved. In this case, when the copolymerization ratio of the ethylene is 50 mol % or less, excellent heat resistance can be exhibited because the fluorine content is relatively high.

When two monomers constitute the fluorine-containing polymer, the balance between polymerization rate and flexibility can be easily adjusted. When one monomer constitutes the fluorine-containing polymer, a homopolymer is obtained; thus, polymerization rate is fast, productivity is excellent, and production costs are kept low. When the fluorine-containing polymer is not crosslinked using a vulcanizing agent and a vulcanization aid, but is thermoplastic, reduction in heat resistance and reduction in productivity due to the vulcanizing agent and the vulcanization aid can be suppressed.

### DESCRIPTION OF EMBODIMENTS

Next, embodiments of the present invention are described in detail.

The insulated electrical wire according to the present invention has a conductor and an insulating layer covering the periphery of the conductor. The insulating layer contains a specific fluorine-containing polymer.

The specific fluorine-containing polymer is a fluorine-containing polymer comprising a polymer of a monomer containing one or two or more fluorine-containing monomers represented by the following formula (1):

[Chem 8]

CH₂═CH—Rf¹ (1)

wherein Rf¹ is a perfluoroalkyl group, and Rf¹ may contain one or more ether bonds.

The above fluorine-containing monomer has a C—H bond in the double-bond portion, and has polymerization reactivity higher than that of perfluoromonomers that have a C—F bond, rather than a C—H bond, in the double-bond portion. Due to the high polymerization reactivity, a relatively high-molecular-weight polymer is obtained, and heat resistance can be thereby increased. That is, while increasing the polymerization reactivity, excellent heat resistance can be ensured. The specific fluorine-containing polymer has inferior heat resistance to perfluoropolymers in which all C—H bonds are replaced by C—F bonds because the specific fluorine-containing polymer has a C—H bond; however, it has a perfluoroalkyl group as Rf¹ in a side chain, which contributes to excellent heat resistance. Moreover, because the specific fluorine-containing polymer has Rf¹ as a side chain, the volume of the side chain increases, and the crystallinity decreases. The flexibility is thereby improved. Therefore, according to the specific fluorine-containing polymer, the flexibility can be improved while maintaining the heat resistance of the fluororesin. There is another advantage that the fluorine-containing monomer has excellent polymerization reactivity.

Examples of the fluorine-containing monomer represented by the formula (1) include fluorine-containing monomers represented by the following formulas (2) to (5). The fluorine-containing monomer represented by the formula (1) may be one of the fluorine-containing monomers represented by the formulas (2) to (5), or a combination of two or more of these monomers.

[Chem 9]

CH₂═CH—Rf² (2)

wherein Rf² is a perfluoroalkyl group comprising a carbon atom and a fluorine atom. The number of carbon atoms of Rf² is one or more, preferably two or more, more preferably three or more, and even more preferably five or more. The effect of increasing the volume of the side chain is excellent, and the softening effect due to reduction in crystallinity is excellent. Moreover, the number of carbon atoms of Rf² is preferably 20 or less. The polymerization rate can be thereby ensured. Further, the fluorine-containing monomer can be easily synthesized. From this viewpoint, the number of carbon atoms of Rf² is more preferably 18 or less, and even more preferably 15 or less. Rf² may be linear or branched.

The fluorine-containing monomer represented by the formula (2) can be synthesized, for example, by reaction of tetrafluoroethylene with perfluoroalkyl trimethoxysilane in the presence of a palladium catalyst or a nickel catalyst.

[Chem 10]

CH₂═CH-0-Rf³ (3)

wherein Rf³ is a perfluoroalkyl group comprising a carbon atom and a fluorine atom. The number of carbon atoms of Rf³ is one or more, preferably two or more, more preferably three or more, and even more preferably five or more. The effect of increasing the volume of the side chain is excellent, and the softening effect due to reduction in crystallinity is excellent. Moreover, the number of carbon atoms of Rf³ is preferably 20 or less. The polymerization rate can be thereby ensured. Further, the fluorine-containing monomer can be easily synthesized. From this viewpoint, the number of carbon atoms of Rf³ is more preferably 18 or less, and even more preferably 15 or less. Rf³ may be linear or branched.

The fluorine-containing monomer represented by the formula (3) can be synthesized, for example, by reaction of tetrafluoroethylene with perfluoroalcohol in the presence of a palladium catalyst or a nickel catalyst.

[Chem 11]

CH₂═CH—CF₂—Rf⁴ (4)

wherein Rf⁴ is a perfluoroalkyl group containing one or more ether bonds. The number of carbon atoms of Rf⁴ is one or more; however, in terms of improving flexibility, the number of carbon atoms of Rf⁴ is preferably two or more. The number of carbon atoms of Rf⁴ is more preferably three or more. Rf⁴ may be linear or branched.

The fluorine-containing monomer represented by the formula (4) can be synthesized, for example, by reaction of tetrafluoroethylene with perfluoroalkyl ether trimethoxysilane in the presence of a palladium catalyst or a nickel catalyst.

Specific examples of the fluorine-containing monomer represented by the formula (4) include a fluorine-containing monomer represented by the following formula (6):

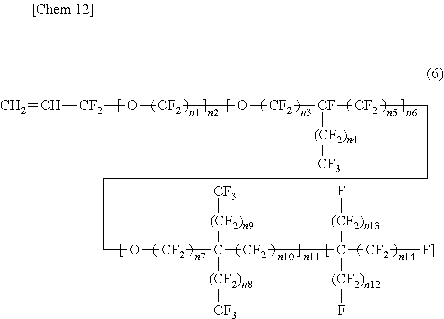

wherein in the formula (6), n1 to n14 are each an integer of 0 or more, except for a case where all of n1 to n11 are 0. This is because if all of n1 to n11 are 0, Rf⁴ of the formula (4) does not contain one or more ether bonds in its structure. From the viewpoint that Rf⁴ of the formula (4) contains one or more ether bonds in its structure, the formula (6) preferably excludes a case where all of n2, n6, and n11 are 0. That is, it is preferable that any one of n2, n6, and n11 be an integer of at least one or more. Moreover, from the viewpoint that Rf⁴ of the formula (4) has two or more carbon atoms, the fluorine-containing monomer represented by the formula (6) preferably has five or more carbon atoms. Furthermore, in terms of excluding peroxy compounds wherein Rf⁴ of the formula (4) has two or more carbon atoms, when n2 is not 0 (an integer of one or more) in the formula (6), it is preferable that n1 be not 0 (an integer of one or more).

In the fluorine-containing monomer represented by the formula (6), the portion corresponding to Rf⁴ of the formula (4) is divided into a first structural block containing one or more ether bonds and comprising a linear chain, a second structural block containing one or more ether bonds and having a branched chain branched from one carbon atom only to one direction, a third structural block containing one or more ether bonds and having a branched chain branched form one carbon atom to two directions, and a fourth structural block comprising a perfluoroalkyl chain that does not contain an ether bond. The first structural block is a structural block surrounded by the first square brackets, and the number of repeating units is n2. The second structural block is a structural block surrounded by the second square brackets, and the number of repeating units is n6. The third structural block is a structural block surrounded by the third square brackets, and the number of repeating units is n11. The fourth structural block is a structural block surrounded by the fourth square brackets, and the number of repeating units is 1.

In the fluorine-containing monomer represented by the formula (6), the number of repeating units (n2, n6, or n11) of each structural block contained therein, and the number of repeating units (n1, n3, n4, n5, n7, n6, n9, n10, n12, n13, or n14) contained in each structural block contained therein are preferably larger. The number of repeating units of each structural block contained therein and the number of repeating units contained in each structural block contained therein are one or more, preferably two or more, and more preferably three or more. The effect of increasing the volume of the side chain is excellent, and the softening effect due to reduction in crystallinity is excellent. In contrast, in terms of softening due to reduction in crystallinity, the upper limit of the number of repeating units (n1 to n14) is preferably an integer of 10 or less when the number of repeating units (n1 to n14) is contained, although it is not particularly limited. The upper limit of the number of repeating units is more preferably an integer of nine or less, and even more preferably an integer of eight or less, an integer of seven or less, an integer of six or less, or an integer of five or less. When the number of n is small, the polymerization rate can be ensured. Moreover, the fluorine-containing monomer can be easily synthesized.

[Chem 13]

CH₂═CH-0-CF₂—Rf⁵ (5)

wherein Rf⁵ is a perfluoroalkyl group containing one or more ether bonds. The number of carbon atoms of Rf⁵ is one or more; however, in terms of improving flexibility, the number of carbon atoms of Rf⁵ is preferably two or more. The number of carbon atoms of Rf⁵ is more preferably three or more. Rf⁵ may be linear or branched.

The fluorine-containing monomer represented by the formula (5) can be synthesized, for example, by reaction of tetrafluoroethylene with perfluoroalkyl ether alcohol in the presence of a palladium catalyst or a nickel catalyst.

Specific examples of the fluorine-containing monomer represented by the formula (5) include a fluorine-containing monomer represented by the following formula (7)

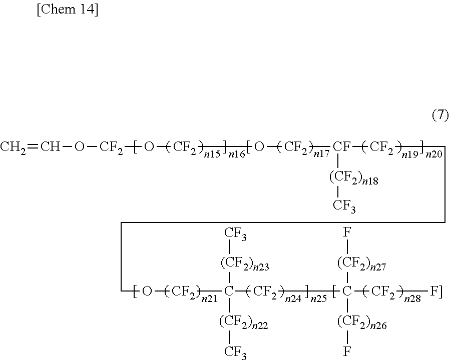

wherein in the formula (7) n15 to n28 are each an integer of 0 or more, except for a case where all of n15 to n25 are 0. This is because if all of n15 to n25 are 0, Rf⁵ of the formula (5) does not contain one or more ether bonds in its structure. From the viewpoint that Rf⁵ of the formula (5) contains one or more ether bonds in its structure, the formula (7) preferably excludes a case where all of n16, n20, and n25 are 0. That is, any one of n16, n20, and n25 is preferably an integer of at least one or more. Moreover, from the viewpoint that Rf⁵ of the formula (5) has two or more carbon atoms, the fluorine-containing monomer represented by the formula (7) preferably has five or more carbon atoms. Furthermore, in terms of excluding peroxy compounds wherein Rf⁵ of the formula (5) has two or more carbon atoms, when n16 is not 0 (an integer of one or more) in the formula (7), it is preferable that n15 be not 0 (an integer of one or more).

In the fluorine-containing monomer represented by the formula (7), the portion corresponding to Rf⁵ of the formula (5) is divided into a first structural block containing one or more ether bonds and comprising a linear chain, a second structural block containing one or more ether bonds and having a branched chain branched from one carbon atom only to one direction, a third structural block containing one or more ether bonds and having a branched chain branched form one carbon atom to two directions, and a fourth structural block comprising a perfluoroalkyl chain that does not contain an ether bond. The first structural block is a structural block surrounded by the first square brackets, and the number of repeating units is n16. The second structural block is a structural block surrounded by the second square brackets, and the number of repeating units is n20. The third structural block is a structural block surrounded by the third square brackets, and the number of repeating units is n25. The fourth structural block is a structural block surrounded by the fourth square brackets, and the number of repeating units is 1.

In the fluorine-containing monomer represented by the formula (7), the number of repeating units (n16, n20, or n25) of each structural block contained therein and the number of repeating units (n15, n17, n18, n19, n21, n22, n23, n24, n26, n27, or n28) contained in each structural block contained therein are preferably larger. The number of repeating units of each structural block contained therein and the number of repeating units contained in each structural block contained therein are one or more, preferably two or more, and more preferably three or more. The effect of increasing the volume of the side chain is excellent, and the softening effect due to reduction in crystallinity is excellent. In contrast, in terms of softening due to reduction in crystallinity, the upper limit of the number of repeating units (n15 to n28) is preferably an integer of 10 or less when the number of repeating units (n15 to n26) is contained, although it is not particularly limited. The upper limit of the number of repeating units is more preferably an integer of nine or less, and even more preferably an integer of eight or less, an integer of seven or less, an integer of six or less, or an integer of five or less. When the number of n is small, the polymerization rate can be ensured. Moreover, the fluorine-containing monomer can be easily synthesized.

In the fluorine-containing monomer represented by the formula (3), a carbon having a C—F bond does not bind to the carbon of the double-bond portion, and oxygen is mediated. Therefore, the reactivity of the double-bond portion is higher than the fluorine-containing monomer represented by the formula (2). That is, the fluorine-containing monomer represented by the formula (3) is superior to the fluorine-containing monomer represented by the formula (2) in terms of polymerization reactivity. Due to the improved polymerizability, the yield of high-molecular-weight polymers can be increased, and heat resistance can be improved. Similarly, the fluorine-containing monomer represented by the formula (5) is superior to the fluorine-containing monomer represented by the formula (4) in terms of polymerization reactivity, and heat resistance can be improved.

The monomer constituting the specific fluorine-containing polymer contains one or two or more fluorine-containing monomers represented by the formula (1), and may be a monomer (A) comprising one or two or more fluorine-containing monomers represented by the formula (1), or a monomer (B) comprising one or two or more fluorine-containing monomer represented by the formula (1) and other ethylenically unsaturated compounds. Examples of other ethylenically unsaturated compounds include ethylene, propylene, and the like. Ethylene is preferred in terms of polymerization reactivity.

When the monomer constituting the specific fluorine-containing polymer is the monomer (A), the specific fluorine-containing polymer is a homopolymer comprising one fluorine-containing monomer represented by the formula (1), or a copolymer of two or more fluorine-containing monomers represented by the formula (1). The copolymer may be, for example, two or more members selected from several types of fluorine-containing monomers represented by any one of the formulas (2) to (5), or two or more members selected from several types of fluorine-containing monomers represented by any of the formulas (2) to (5), regardless of whether the formulas are same or different. When the monomer constituting the specific fluorine-containing polymer is the monomer (A), the fluorine content is often relatively higher than the monomer (B); thus, excellent heat resistance can be exhibited.

In the case where the monomer constituting the specific fluorine-containing polymer is the monomer (B), when the other ethylenically unsaturated compound is ethylene, the specific fluorine-containing polymer may be a copolymer of one fluorine-containing monomer represented by the formula (1) and ethylene, or a copolymer of two or more fluorine-containing monomers represented by the formula (1) and ethylene. The two or more fluorine-containing monomers represented by the formula (1) may be, for example, selected from several types of fluorine-containing monomers represented by any one of the formulas (2) to (5), or selected from several types of fluorine-containing monomers represented by any of the formulas (2) to (5), regardless of whether the formulas are same or different. In the case where the monomer constituting the specific fluorine-containing polymer is the monomer (B) when ethylene, propylene, or the like is used, polymerization reactivity is more improved than the monomer (A), although it depends on the other ethylenically unsaturated compound; thus, the yield of high-molecular-weight polymers can be increased, and heat resistance can be improved.

When the monomer constituting the specific fluorine-containing polymer is the monomer (B), the ratio of the other ethylenically unsaturated compound, such as ethylene, is preferably 50 mol % or less. When the copolymerization ratio is 50 mol % or less, the fluorine content is relatively high; thus, excellent heat resistance can be exhibited. From this viewpoint, the copolymerization ratio is more preferably 40 mol % or less, and even more preferably 30 mol % or less. When the ratio of the other ethylenically unsaturated compound increases, heat resistance and flexibility tend to decrease. On the contrary, abrasion resistance tends to increase.

The monomer constituting the specific fluorine-containing polymer comprises one or more members including the fluorine-containing monomer represented by the formula (1); however, the monomer preferably comprises, for example, two members selected from the fluorine-containing monomers represented by the formula (1) and other ethylenically unsaturated compounds. In this case, the two members may be selected from the fluorine-containing monomers represented by the formula (1), or one may be selected from the fluorine-containing monomers represented by the formula (1) and the other may be selected from other ethylenically unsaturated compounds. When two monomers are used, a copolymer having side chains with different lengths is obtained. The long side-chain portion contributes to reduction in crystallinity and improvement of flexibility. The short side-chain portion contributes to increase in the mobility of molecules and improvement of polymerization reactivity. When two monomers are used, polymerization reactivity and flexibility can be balanced. The balance between polymerization reactivity and flexibility can be adjusted by changing the side chain length.

When two monomers are used, the difference of the side chain length (the number of carbon atoms) is preferably five or more, more preferably eight or more, and even more preferably ten or more. Flexibility can be further increased by increasing the difference of the side chain length (the number of carbon atoms). The number of carbon atoms in the side chain of the short-chain monomer is preferably 0 to 4, more preferably 1 to 4, and even more preferably 2 or 3. The number of carbon atoms in the side chain of the long-chain monomer is preferably 5 to 20, more preferably 6 to 16, and even more preferably 10 to 12.

When two monomers are used, the copolymer ratio, as molar ratio, is preferably such that the ratio of short-chain monomer to long-chain monomer is within the range of 1:9 to 9:1, more preferably 3:7 to 7:3, and even more preferably 4:6 to 6:4. Polymerization reactivity can be enhanced by increasing the ratio of short-chain monomer. Flexibility can be enhanced by increasing the ratio of long-chain monomer.

Moreover, the monomer constituting the specific fluorine-containing polymer is preferably, for example, one member selected from the fluorine-containing monomers represented by the formula (1). When one monomer constitutes the fluorine-containing polymer, a homopolymer is obtained; thus, polymerization rate is fast, productivity is excellent, and production costs are kept low.

In the specific fluorine-containing polymer, the above fluorine-containing monomer and the other ethylenically unsaturated compound, which is optionally used, both have a C—H bond in the double-bond portion, and the specific fluorine-containing polymer can be synthesized by polymerization in the same manner as in ethylene polymerization. More specifically, the specific fluorine-containing polymer can be synthesized by cationic polymerization using ethyldichloroaluminum or the like. If necessary, weak Lewis acid, such as ethyl acetate, 1,4-dioxane, or tetrahydrofuran, may be used during polymerization.

The specific fluorine-containing polymer is preferably thermoplastic. That is, the specific fluorine-containing polymer is preferably not one that is crosslinked using a vulcanizing agent and a vulcanization aid. When the specific fluorine-containing polymer is not crosslinked using a vulcanizing agent and a vulcanization aid, but is thermoplastic, reduction in heat resistance and reduction in productivity due to the vulcanizing agent and the vulcanization aid can be suppressed.

The insulating layer is formed from a resin composition containing the specific fluorine-containing polymer. The resin composition may contain polymer components other than the specific fluorine-containing polymer within a range that does not affect the heat resistance and flexibility of the insulated electrical wire of the present invention; however, in consideration of the heat resistance and flexibility of the insulated electrical wire of the present invention, it is preferable that the resin composition do not contain any polymer components other than the specific fluorine-containing polymer. Examples of polymer components other than the specific fluorine-containing polymer include polyethylene, polypropylene, ethylene-vinyl acetate copolymers (EVA), ethylene-ethyl acrylate copolymers (EEA), and the like, because they have excellent electrical wire properties.

In addition to the polymer components, such as the specific fluorine-containing polymer, the resin composition may contain various additives that are to be mixed in electrical wire-covering materials. Examples of such additives include flame retardants, processing aids, lubricants, UV absorbers, antioxidants, stabilizers, fillers, and the like.

Examples of fillers include calcium carbonate, barium sulfate, clay, talc, magnesium hydroxide, magnesium oxide, and the like. They improve the abrasion resistance of the resin composition. The average particle diameter of the filler is preferably 1.0 μm or less in terms of dispersibility in the resin composition. Moreover, in terms of handling properties etc., the average particle diameter of the filler is preferably 0.01 μm or more. The average particle diameter of the filler can be measured by a laser light scattering method.

The filler content is preferably 0.1 part by mass or more based on 100 parts by mass of the polymer components, such as the specific fluorine-containing polymer, in terms of excellent abrasion resistance. The filler content is more preferably 0.5 parts by mass or more, and even more preferably 1.0 part by mass or more. In contrast, in terms of suppressing appearance deterioration and ensuring flexibility and cold resistance, the filler content is preferably 100 parts by mass or less based on 100 parts by mass of the polymer components, such as the specific fluorine-containing polymer. The filler content is more preferably 50 parts by mass or less, and even more preferably 30 parts by mass or less.

The filler may be subjected to surface-treatment in terms of, for example, suppressing aggregation and increasing affinity with the specific fluorine-containing polymer. Examples of surface-treating agents include homopolymers or mutual copolymers of α-olefins, such as 1-heptene, 1-octene, 1-nonene, and 1-decene; mixtures thereof; fatty acid, rosin acid, silane coupling agents, and the like.

These surface-treating agents may be modified. Usable modifying agents include unsaturated carboxylic acids and derivatives thereof. Specific examples of unsaturated carboxylic acids include maleic acid, fumaric acid, and the like. Specific examples of derivatives of unsaturated carboxylic acids include maleic anhydride (MAH), maleic acid monoester, maleic acid diester, and the like. Among these, maleic acid, maleic anhydride, etc., are preferred. These modifying agents for surface-treating agents may be used singly or in combination of two or more.

Examples of the method for introducing an acid into a surface-treating agent include a grafting method, a direct method, and the like. The acid modification amount is 0.1 to 20 mass %, preferably 0.2 to 10 mass %, and more preferably 0.2 to 5 mass %, of the surface-treating agent.

The surface treatment method using a surface-treating agent is not particularly limited. For example, the filler mentioned above may be surface-treated, or the treatment may be performed simultaneously with the synthesis of the filler. The treatment method may be a wet process using a solvent or a dry process not using a solvent. Usable examples of solvents suitable for the wet process include aliphatic solvents, such as pentane, hexane, and heptane; and aromatic solvents, such as benzene, toluene, and xylene. Moreover, when the resin composition of the insulating layer is prepared, a surface-treating agent may be kneaded simultaneously with materials, such as the specific copolymer.

Calcium carbonate includes synthetic calcium carbonate formed by chemical reaction, and ground calcium carbonate formed by grinding limestone. Synthetic calcium carbonate can be used as fine particles with a primary particle diameter of a submicron size (about several tens of nm) or less by performing surface-treatment using a surface-treating agent, such as fatty acid, rosin acid, or a silane coupling agent. The average particle diameter of the surface-treated fine particles is expressed as primary particle diameter. The primary particle diameter can be measured by observation with an electron microscope. Ground calcium carbonate is a pulverized product, and can be used as particles with an average particle diameter of several hundreds of nm to about 1 μm, without performing surface-treatment using fatty acid or the like. The calcium carbonate may be synthetic calcium carbonate or ground calcium carbonate.

Specific examples of calcium carbonate include Hakuenka CC (average particle diameter=0.05 μm), Hakuenka CCR (average particle diameter=0.08 μm), Hakuenka DD (average particle diameter=0.05 μm), Vigot 10 (average particle diameter=0.10 μm), Vigot 15 (average particle diameter=0.15 μm), and Hakuenka U (average particle diameter=0.04 μm), all of which are produced by Shiraishi Calcium Kaisha, Ltd.

Specific examples of magnesium oxide include UC95S (average particle diameter=3.1 μm), UC95M (average particle diameter=3.0 μm), and UC95H (average particle diameter=3.3 μm), all of which are produced by Ube Material Industries, Ltd.

Usable examples of magnesium hydroxide include magnesium hydroxide synthesized from seawater by a crystal growth method, synthetic magnesium hydroxide synthesized by reaction of magnesium chloride with calcium hydroxide, natural magnesium hydroxide obtained by grinding naturally-occurring minerals, and the like. Specific examples of magnesium hydroxide as the filler include UD-650-1 (average particle diameter=3.5 μm) and UD653 (average particle diameter=3.5 μm), both of which are produced by Ube Material Industries, Ltd.

The insulating layer can be formed, for example, in the following manner. Specifically, the above-mentioned resin composition for insulating layers for forming an insulating layer is first prepared. Subsequently, the prepared resin composition is extruded to the periphery of a conductor to mold an insulating layer containing the above specific copolymer in the periphery of the conductor. The resin composition can be prepared by kneading the specific fluorine-containing polymer and optionally mixed additives, such as a filler. For the kneading of the components of the resin composition, a general kneader, such as a Banbury mixer, a pressurizing kneader, a kneading extruder, a twin-screw kneading extruder, or a roll, can be used.

In the extrusion molding of the resin composition for insulating layers, an electrical wire extrusion molding machine or the like used for the production of general insulated electrical wires can be used. As the conductor, those used for general insulated electrical wires can be used. Examples thereof include single-wire conductors and strand-wire conductors, both of which comprise a copper-based material or an aluminum-based material. The diameter of the conductor, the thickness of the insulating layer, etc., are not particularly limited, and can be suitably determined depending on the purpose of the insulated electrical wire, etc.

The embodiments of the present invention are described in detail above; however, the present invention is not limited to the above embodiments, and various modifications can be made within a range that does not depart from the gist of the present invention. For example, the insulated electrical wire of the above embodiment is formed from a single insulating layer; however, the insulated electrical wire of the present invention may be formed from two or more insulating layers.

The insulated electrical wire according to the present invention can be used for insulated electrical wires for use in automobiles, and electronic and electric devices. In particular, the insulated electrical wire according to the present invention is an insulated electrical wire having improved flexibility while maintaining the heat resistance of the fluororesin, and is thus suitable as an insulated electrical wire to be applied to places for which heat resistance and flexibility are required. Examples of such insulated electrical wires include power cables and the like. Power cables connect engines and batteries of hybrid cars or electric cars. Because high-voltage and high-current electricity flows through power cables, they are relatively thick insulated electrical wires. High heat resistance and excellent flexibility, in spite of thick wires, are required.

The conductor cross-sectional area of insulated electrical wires with a relatively large diameter suitable for power cables etc. is 3 mm² or more. In this case, the thickness of the insulating layer is suitably determined depending on the conductor cross-sectional area. For example, when the conductor cross-sectional area is 3 mm², the thickness of the insulating layer is 0.5 mm or more. Moreover, when the conductor cross-sectional area is 15 mm², the thickness of the insulating layer is 1.0 mm or more.

The insulated electrical wire according to the present invention is an insulated electrical wire having improved flexibility while maintaining the heat resistance of the fluororesin. Flexibility can be evaluated as the flexural modulus of the above-mentioned specific copolymer used as an insulating material. The flexural modulus is a numerical value measured in an absolute dry state at 23° C. according to “Plastics—Determination of flexural properties” in IS0178 (ASTM-D790). The flexural modulus of the specific fluorine-containing polymer is preferably 200 MPa or less, in terms of satisfying the flexibility of the insulated electrical wire according to the present invention. The flexural modulus of the specific fluorine-containing polymer is more preferably 150 MPa or less, and even more preferably 100 MPa or less.

### EXAMPLES

Examples and Comparative Examples of the present invention are shown below.

### Examples 1 to 10

The monomer of the formula (2) (CH₂═CH—Rf²), the monomer of the formula (3) (CH₂═CH—O—Rf³), the monomer of the formula (6), and the monomer of the formula (7) were placed so as to satisfy the polymerization ratio (part by mass) shown in Table 1, and cationic polymerization was performed to synthesize fluorine-containing polymers. The structure of the carbon side chain is expressed as linear or branched. The branched chain has a tert-butyl group at the terminal of the side chain. Each of the obtained fluorine-containing polymers and an optionally added filler were mixed so as to achieve the formation (part by mass) shown in Table 1, thereby preparing resin compositions for insulating layers. Subsequently, the outer periphery of an annealed copper stranded wire conductor (cross-sectional area: 15 mm²) obtained by stranding 171 annealed copper wires was covered by extrusion with each of the resin compositions for insulating layers with a thickness of 1.1 mm using an extrusion molding machine (350° C.). Insulated electrical wires of Examples 1 to 10 were obtained in the above manner.

### Example 11

An insulated electrical wire was obtained in the same manner as in Example 10, except that ethylene was contained as a copolymerization component.

### Comparative Examples 1 to 6

Insulated electrical wires of Comparative Examples 1 to 6 were obtained in the same manner as in the Examples, except that each monomer was placed so as to satisfy the polymerization ratio (part by mass) shown in Table 2.

### Comparative Example 7

An insulated electrical wire of Comparative Example 7 was obtained in the same manner as in the Examples, except that commercially available FEP (“9494-J,” produced by Du Pont-Mitsui Fluorochemicals Co., Ltd.) was used as the fluororesin.

### Comparative Examples 8 to 13

Insulated electrical wires of Comparative Examples 8 to 13 were obtained in the same manner as in the Examples, except that each monomer was placed so as to satisfy the polymerization ratio (part by mass) shown in Table 3.

### Comparative Example 14

An insulated electrical wire of Comparative Example 14 was obtained in the same manner as in the Examples, except that commercially available PFA (“420 HP-J,” produced by Du Pont-Mitsui Fluorochemicals Co., Ltd., side chain=methoxy group) was used as the fluororesin.

The flexibility of the insulated electrical wires of Examples 1 to 11 and Comparative Examples 1 to 14 was evaluated. Further, their abrasion resistance was also evaluated. Tables 1 to 3 show the results. The test method and evaluation are as described below.

[Flexibility Test Method]

The insulated electrical wires of the Examples and Comparative Examples were each cut into a length of 500 mm to prepare test pieces, and the resulting test pieces were fixed with a bend radius of 100 mm. Subsequently, stress was applied using a load cell, and the maximum load when each test piece was pressed until the bend radius was 50 mm was measured.

[Abrasion Resistance Test Method]

A test was conducted by a blade-reciprocating method according to “JASO D618,” Technical Standards by the Society of Automotive Engineers of Japan, Inc. Specifically, the insulated electrical wires of the Examples and Comparative Examples were each cut into a length of 750 mm to prepare test pieces. Then, a blade was reciprocated on the covering material (insulating layer) of each test piece at room temperature of 23±5° C. at a rate of 50 times per minute with a length of 10 mm or more in the axial direction, and the number of times of reciprocation until the blade contacted the conductor was measured. In this case, the load on the blade was set to 7 N. Regarding the number of times, 1500 times or more was regarded as acceptable “◯,” and less than 1500 times was regarded as failed “X.” Moreover, 2000 times or more was regarded as particularly excellent “⊚.”

TABLE 1

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| Monomer (2) (Rf² 2 | 100 | | 50 | 50 | | | 5 | | | | |
| carbon atoms, linear) | | | | | | | | | | | |
| (part by mass) | | | | | | | | | | | |
| Monomer (2) (Rf² 6 | | | 50 | | | | | | | | |
| carbon atoms, linear) | | | | | | | | | | | |
| (part by mass) | | | | | | | | | | | |
| Monomer (2) (Rf² 12 | | | | 50 | | | | | | | |
| carbon atoms, linear) | | | | | | | | | | | |
| (part by mass) | | | | | | | | | | | |
| Monomer (3) (Rf³ 4 | | 100 | | | 50 | 50 | 5 | | | | |
| carbon atoms, linear) | | | | | | | | | | | |
| (part by mass) | | | | | | | | | | | |
| Monomer (3) (Rf³ 8 | | | | | 50 | | | | | | |
| carbon atoms, linear) | | | | | | | | | | | |
| (part by mass) | | | | | | | | | | | |
| Monomer (3) (Rf³ 16 | | | | | | 50 | | | | | |
| carbon atoms, | | | | | | | | | | | |
| branched) (part by | | | | | | | | | | | |
| mass) | | | | | | | | | | | |
| Monomer (6) (part by | | | | | | | 45 | 40 | 100 | | |
| mass) | | | | | | | | | | | |
| n1 | | | | | | | 1 | 2 | 1 | | |
| n2 | | | | | | | 2 | 1 | 2 | | |
| n3 | | | | | | | 1 | 2 | 2 | | |
| n4 | | | | | | | 2 | 1 | 1 | | |
| n5 | | | | | | | 3 | 0 | 2 | | |
| n6 | | | | | | | 2 | 0 | 2 | | |
| n7 | | | | | | | 0 | 2 | 2 | | |
| n8 | | | | | | | 0 | 3 | 3 | | |
| n9 | | | | | | | 0 | 2 | 2 | | |
| n10 | | | | | | | 0 | 3 | 3 | | |
| n11 | | | | | | | 0 | 2 | 3 | | |
| n12 | | | | | | | 1 | 1 | 1 | | |
| n13 | | | | | | | 1 | 3 | 3 | | |
| n14 | | | | | | | 1 | 2 | 3 | | |
| Monomer (7) (part by | | | | | | | 45 | 60 | | 100 | 50 |
| mass) | | | | | | | | | | | |
| n15 | | | | | | | 2 | 2 | | 1 | 1 |
| n16 | | | | | | | 2 | 2 | | 2 | 2 |
| n17 | | | | | | | 3 | 2 | | 2 | 2 |
| n18 | | | | | | | 2 | 1 | | 1 | 1 |
| n19 | | | | | | | 3 | 0 | | 2 | 2 |
| n20 | | | | | | | 1 | 0 | | 2 | 2 |
| n21 | | | | | | | 0 | 2 | | 1 | 1 |
| n22 | | | | | | | 0 | 2 | | 1 | 1 |
| n23 | | | | | | | 0 | 2 | | 2 | 2 |
| n24 | | | | | | | 0 | 2 | | 2 | 2 |
| n25 | | | | | | | 0 | 3 | | 2 | 2 |
| n26 | | | | | | | 1 | 1 | | 1 | 1 |
| n27 | | | | | | | 1 | 3 | | 1 | 1 |
| n28 | | | | | | | 1 | 1 | | 3 | 3 |
| Ethylene (part by mass) | | | | | | | | | | | 50 |
| UC95S (part by mass) | | | | | | | | | | 15 | 15 |
| Flexibility (N) | 26 | 23 | 18 | 14 | 17 | 13 | 10 | 5 | 8 | 9 | 12 |
| Abrasion resistance | ⊚ | ◯ | ◯ | ◯ | ◯ | ◯ | ◯ | ◯ | ◯ | ⊚ | ⊚ |

TABLE 2

| | Comparative Example | | | | | | |
|---|---|---|---|---|---|---|---|
| | 1 | 2 | 3 | 4 | 5 | 6 | 7 |
| CF₂ = CF₂ (part by mass) | 95 | 94 | 93 | 92 | 91 | 91 | |
| CF₂ = CF—CF₃ (part by mass) | 5 | 6 | 7 | 8 | 9 | 9 | |
| FEP (9494-J) | | | | | | | 100 |
| UD-650-1 | | | | | | 5 | |
| Flexibility (N) | 50 | 48 | 46 | 44 | 42 | 45 | 47 |
| Abrasion resistance | ⊚ | ⊚ | ⊚ | ⊚ | ◯ | ⊚ | ⊚ |

TABLE 3

| | Comparative Example | | | | | | |
|---|---|---|---|---|---|---|---|
| | 8 | 9 | 10 | 11 | 12 | 13 | 14 |
| CF₂ = CF₂ (part by mass) | 95 | 94 | 93 | 92 | 91 | 91 | |
| CF₂ = CF—O—CF₃ (part by mass) | 5 | | | | | | |
| CF₂ = CF—O—CF₂—CF₃(part by | | 6 | | | | | |
| mass) | | | | | | | |
| CF₂ = CF—O—CF₂—CF₂—CF₃ | | | 7 | 8 | 9 | 9 | |
| (part by mass) | | | | | | | |
| PFA (420 HP-J) | | | | | | | 100 |
| UD-650-1 | | | | | | 5 | |
| Flexibility (N) | 55 | 52 | 48 | 43 | 41 | 44 | 53 |
| Abrasion resistance | ⊚ | ⊚ | ⊚ | ⊚ | ◯ | ⊚ | ⊚ |

In Comparative Example 7, commercially available FEP is used as the material of the insulating layer. The commercially available FEP is insufficient in terms of flexibility. Comparative Examples 1 to 6 are perfluorocopolymers containing tetrafluoroethylene as a monomer, as with the commercially available FEP, and use a fluororesin having a side chain with 1 carbon atom as the material of the insulating layer. All of them are insufficient in terms of flexibility.

In Comparative Example 14, commercially available PFA is used as the material of the insulating layer. The commercially available PFA is insufficient in terms of flexibility. Comparative Examples 8 to 13 are perfluorocopolymers containing tetrafluoroethylene as a monomer, as with the commercially available PFA, and use a fluororesin having a side chain (perfluoroalkoxy group) with 1 to 3 carbon atoms as the material of the insulating layer. All of them are insufficient in terms of flexibility.

In contrast, the Examples use, as the material of the insulating layer, a fluorine-containing polymer comprising one or two or more fluorine-containing monomers represented by the formula (1) (CH₂═CH—Rf¹), or a fluorine-containing polymer comprising a copolymer of a fluorine-containing monomer represented by the formula (1) (CH₂═CH—Rf¹) and ethylene. Accordingly, they are sufficiently satisfactory in terms of flexibility. Moreover, heat resistance is also very high because they are fluorine-containing polymers. Furthermore, the monomer has a C—H bond in the double-bond portion, has excellent polymerization reactivity, and can efficiently produce fluorine-containing polymers.

Compared with Examples 1 and 2, the maximum load of Examples 3 to 6 in the flexibility evaluation is 20 N or less. This reveals that they have more superior flexibility. This is presumably because they contain a fluorine-containing monomer having a side chain with 5 or more carbon atoms, or use two types of fluorine-containing monomers. In Examples 4, 6, and 11, which contain a fluorine-containing monomer having a side chain with 10 or more carbon atoms, the maximum load in the flexibility evaluation is 15 N or less. This reveals that they have much more superior flexibility. Moreover, the maximum load of Examples 7 to 10 in the flexibility evaluation is 10 N or less. This reveals that they particularly have excellent flexibility. This is presumably because they use the fluoromonomers of the formulas (6) and (7), both of which have side chains with many carbon atoms and have many branches when formed into polymers.

The embodiments of the present invention are described in detail above; however, the present invention is not limited to the above embodiments, and various modifications can be made within a range that does not depart from the gist of the present invention.

1. An insulated electrical wire comprising a conductor and an insulating layer covering the periphery of the conductor, the insulating layer containing a fluorine-containing polymer comprising a polymer of a monomer containing at least one fluorine-containing represented by the following formula (1):
[Chem 1]
CH₂═CH—Rf¹ (1)
wherein Rf¹ is a perfluoroalkyl group, and Rf¹ may contain one or more ether bonds.

2. The insulated electrical wire according to claim 1, wherein the fluorine-containing monomer represented by the formula (1) is at least one fluorine-containing monomer represented by the following formulas (2) to (5):
[Chem 2]
CH₂═CH—Rf² (2)
wherein Rf² is a perfluoroalkyl group;
[Chem 3]
CH₂═CH-0-Rf³ (3)
wherein Rf³ is a perfluoroalkyl group;
[Chem 4]
CH₂═CH—CF₂—Rf⁴ (4)
wherein Rf⁴ is a perfluoroalkyl group containing one or more ether bonds; and
[Chem 5]
CH₂═CH-0-CF₂—Rf⁵ (5)
wherein Rf⁵ is a perfluoroalkyl group containing one or more ether bonds.

3. The insulated electrical wire according to claim 2, wherein the fluorine-containing monomer represented by the formula (4) is present and is a fluorine-containing monomer represented by the following formula (6): 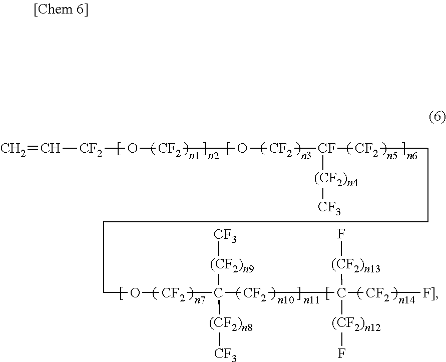
wherein n1 to n14 are each an integer of 0 or more, except for a case where all of n1 to n11 are 0.

4. The insulated electrical wire according to claim 2, wherein the fluorine-containing monomer represented by the formula (5) is present and is a fluorine-containing monomer represented by the following formula (7): 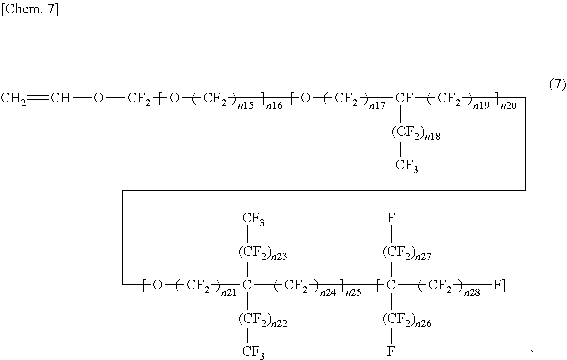
wherein n15 to n28 are each an integer of 0 or more, except for a case where all of n15 to n25 are 0.

5. The insulated electrical wire according to claim 1, wherein the periphery of the conductor is covered with an insulating layer containing a fluorine-containing polymer comprising a copolymer of at least one fluorine-containing monomer represented by the formula (1) and another ethylenically unsaturated compound.

6. The insulated electrical wire according to claim 1, wherein the periphery of the conductor is covered with an insulating layer containing a fluorine-containing polymer comprising a copolymer of at least one fluorine-containing monomer represented by the formula (1) and ethylene.

7. The insulated electrical wire according to claim 1, wherein the fluorine-containing polymer is a copolymer of the fluorine-containing monomer represented by formula (1) and another monomer.

8. The insulated electrical wire according to claim 1, wherein the fluorine-containing polymer is a homopolymer of the fluorine-containing monomer represented by formula (1).

9. The insulated electrical wire according to claim 6, wherein the copolymerization ratio of the ethylene is 50 mol % or less.

10. The insulated electrical wire according to claim 1, wherein the fluorine-containing polymer is thermoplastic.
